(19) United States
(12) Patent Application Publication
(10) Pub. No.: US 2017/0052385 A1
(43) Pub. Date: Feb. 23, 2017

(54) LENS FOCUSING METHOD AND OPTICAL MODULE

(71) Applicant: CHICONY ELECTRONICS CO., LTD., NEW TAIPEI CITY (TW)

(72) Inventors: JUI-CHING WU, NEW TAIPEI CITY (TW); JIN-KAE JANG, NEW TAIPEI CITY (TW); TSUNG-YOU WANG, NEW TAIPEI CITY (TW)

(21) Appl. No.: 15/004,994

(22) Filed: Jan. 24, 2016

(30) Foreign Application Priority Data
Aug. 18, 2015 (TW) 104126851

(51) Int. Cl. G02B 27/62; B32B 37/12; H04N 5/225; G02B 7/02; G03B 43/00

(52) U.S. Cl. CPC G02B 27/62; G02B 7/022; G02B 7/025; G03B 43/00; H04N 5/2254; B32B 37/12; B32B 2037/1253; B32B 2551/00; B32B 2457/08

(57) ABSTRACT

A lens focusing method includes the following steps. A holder is disposed on a printed circuit board, such that the holder surrounds an image sensor that is on the printed circuit board. A lens assembly is rotated to position in the holder through a first thread of the holder and a second thread of the lens assembly. A tilt of the holder is adjusted, such that an optic axis of the lens assembly is perpendicular to the image sensor. The lens assembly is rotated to move to a focal plane in a vertical direction through the first and second threads again.

### RELATED APPLICATIONS

This application claims priority to Taiwanese Application Serial Number 104126851, filed Aug. 18, 2015, which is herein incorporated by reference.

### BACKGROUND

Field of Invention

The present invention relates to a lens focusing method and an optical module.

Description of Related Art

In the current market of various electronic products, many products have extensively utilized optical modules that have lenses to receive image information. For example, optical modules having lenses may be assembled to cellular phones, notebook computers, cameras, and equipment of medical science.

During assembly of an optical module, in order to form a good image generated by an image sensor after a lens assembly is installed, a thread focusing method or an active alignment (AA) focusing method is often utilized to adjust the focal length of the lens assembly. When the thread focusing method is used, the lens assembly is connected to a holder that is fixed on a printed circuit board through the threads of the lens assembly and the holder. Thereafter, the lens assembly is rotated to a focal plane. However, in this method, when the holder or the image sensor is not evenly assembled to the printed circuit board, the optic axis of the lens assembly is not perpendicular to the image sensor, such that the corner region of an image is easily fuzzy.

When the active alignment focusing method is used, the lens assembly is clamped into the holder and is moved to a focal plane. Thereafter, the tilt of the lens assembly is adjusted to a position that the optic axis is perpendicular to the image sensor. Subsequently, glue is dispensed to fix the lens assembly. However, in this method, when the tilt of the lens assembly is adjusted, it is possible to leave the focal plane, such that the central region of an image easily has poor resolution.

### SUMMARY

An aspect of the present invention is to provide a lens focusing method.

According to an embodiment of the present invention, a lens focusing method includes the following steps. A holder is disposed on a printed circuit board, such that the holder surrounds an image sensor that is on the printed circuit board. A lens assembly is rotated to position in the holder through a first thread of the holder and a second thread of the lens assembly. A tilt of the holder is adjusted, such that an optic axis of the lens assembly is perpendicular to the image sensor. The lens assembly is rotated to move to a focal plane in a vertical direction through the first and second threads again.

Another aspect of the present invention is to provide an optical module.

According to an embodiment of the present invention, an optical module includes a printed circuit board, an image sensor, a holder, and a lens assembly. The image sensor is located on the printed circuit board. The holder is located on the printed circuit board and surrounds the image sensor. The holder has an accommodating space and a first thread, and the first thread is located on the wall surface of the holder facing the accommodating space. At least a portion of the lens assembly is located in the accommodating space and has a second thread. The holder is oblique relative to the printed circuit board, such that an optic axis of the lens assembly is perpendicular to the image sensor.

In the aforementioned embodiments of the present invention, the lens assembly is combined with the holder through the first and second threads. When the tilt of the holder is adjusted, the lens assembly is shifted along with the holder (e.g., a left shift or a right shift). Hence, the lens assembly may be adjusted to a position that the optic axis thereof is perpendicular to the image sensor. After the tilt of the holder is adjusted, the lens assembly may be rotated to move in a vertical direction in the holder (e.g., up and down). Therefore, the lens assembly may be adjusted to a position of the focal plane. As a result, the lens focusing method and the optical module of the present invention can improve not only the resolution of the corner region of an image, but also the resolution of the central region of an image.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow chart of a lens focusing method according to one embodiment of the present invention;

FIG. 2 is a top view of a printed circuit board and an image sensor according to one embodiment of the present invention;

FIG. 3 is a schematic view of a holder and a lens assembly after being disposed on the printed circuit board shown in FIG. 2;

FIG. 4 is a schematic view of the holder shown in FIG. 3 after being clamped by a robotic arm;

FIG. 5 is a schematic view of the holder shown in FIG. 4 after being adjusted a tilt thereof;

FIG. 6 is a schematic view of a gap shown in FIG. 5 after being filled with a light-curing adhesive and after the light-curing adhesive is cured; and

FIG. 7 is a schematic view of the lens assembly and the holder shown in FIG. 6 after being fixed by glue.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

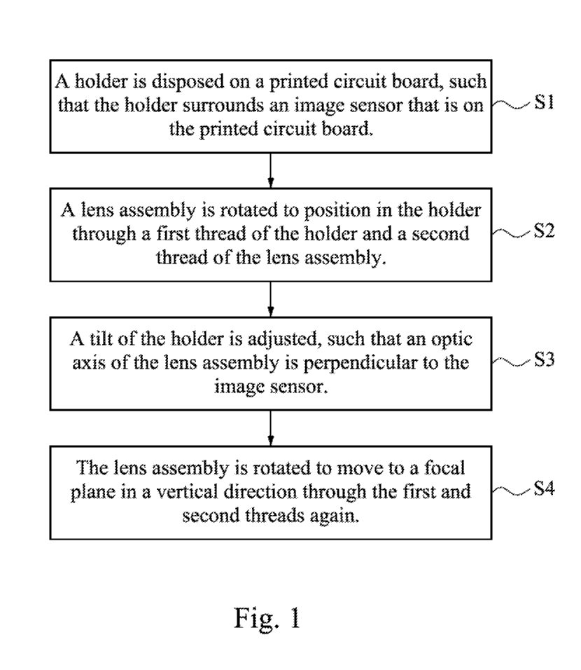

FIG. 1 is a flow chart of a lens focusing method according to one embodiment of the present invention. The lens focusing method includes the following steps. In step S1, a holder is disposed on a printed circuit board, such that the holder surrounds an image sensor that is on the printed circuit board. Thereafter, in step S2, a lens assembly is rotated to position in the holder through a first thread of the holder and a second thread of the lens assembly. Subsequently, in step S3, a tilt of the holder is adjusted, such that an optic axis of the lens assembly is perpendicular to the image sensor. Finally, in step S4, the lens assembly is rotated to move to a focal plane in a vertical direction through the first and second threads again.

In the following description, the aforesaid steps will be described in detail.

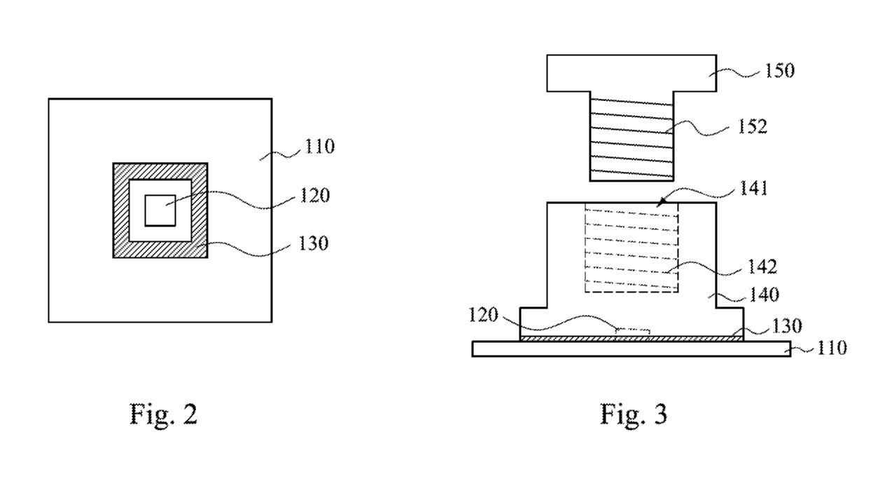

FIG. 2 is a top view of a printed circuit board 110 and an image sensor 120 according to one embodiment of the present invention. As shown in FIG. 2, the image sensor 120 is located on the printed circuit board 110. The image sensor 120 may be fixed to the printed circuit board 110 by surface mount technology (SMT), such that the image sensor 120 is electrically connected to the printed circuit board 110. In addition, a light-curing adhesive 130 may be dispensed to the printed circuit board 110, such that the light-curing adhesive 130 surrounds the image sensor 120. In this embodiment, preferably, the image sensor 120 may be a CMOS chip or a CCD chip, and the light-curing adhesive 130 may be an ultraviolet curing adhesive, but the present invention is not limited in this regard.

FIG. 3 is a schematic view of a holder 140 and a lens assembly 150 after being disposed on the printed circuit board 110 shown in FIG. 2. As shown in FIG. 2 and FIG. 3, after the light-curing adhesive 130 surrounds the image sensor 1.20, the holder 140 may be disposed on the printed circuit board 110, such that the holder 140 surrounds the image sensor 120 that is on the printed circuit board 110. The light-curing adhesive 130 is utilized to adhere the holder 140 to the printed circuit board 110. In this embodiment, the holder 140 has an accommodating space 141 and a first thread 142, and the lens assembly 150 has a second thread 152. After the holder 140 is adhered to the printed circuit board 110, the lens assembly 150 may be rotated to position in the holder 140 through the first and second threads 142, 152, but the present invention is not limited in this regard.

In another embodiment, the lens assembly 150 may be rotated to position in the holder 140 first, and then the lens assembly 150 and the holder 140 are together assembled to the printed circuit board 110, such that the holder 140 is adhered to the printed circuit board 110 by the light-curing adhesive 130.

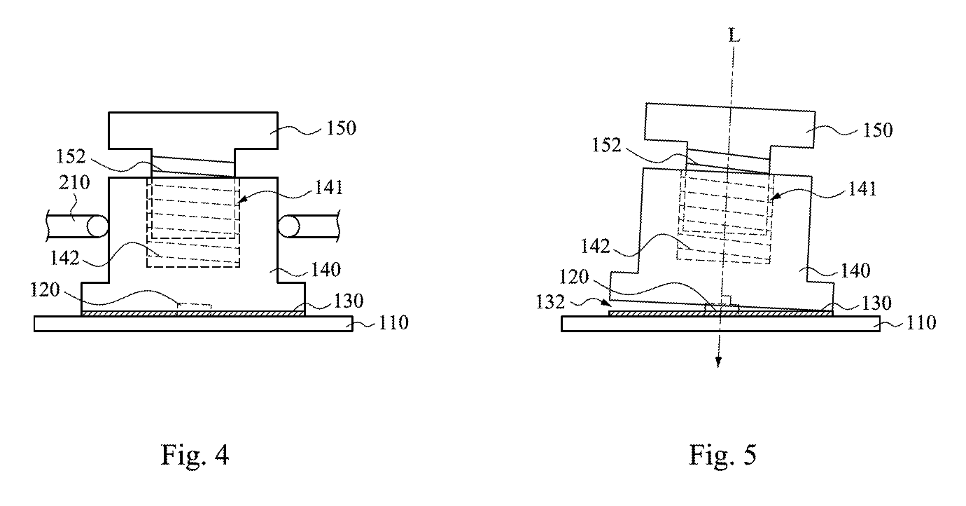

FIG. 4 is a schematic view of the holder 140 shown in FIG. 3 after being clamped by a robotic arm 210. As shown in FIG. 3 and FIG. 4, after the lens assembly 150 is assembled to the holder 140, the robotic arm 210 may clamp the holder 140. In this embodiment, due to manufacturing errors, the image sensor 120 is obliquely located on the printed circuit board 110. Since the light-curing adhesive 130 is not exposed by a light (e.g., an ultraviolet light) that corresponds to the wavelength of the light-curing adhesive 130 yet for previous curing and a baking process is not performed on the light-curing adhesive 130 in a high temperature yet for thermal curing, the holder 140 is only temporally positioned on the printed circuit board 110. When the holder 140 on the printed circuit board 110 receives a force, the tilt of the holder 140 still can be adjusted. In this embodiment, the robotic arm 210 is utilized to clamp the holder 140 to adjust the tilt of the holder 140.

FIG. 5 is a schematic view of the holder 140 shown in FIG. 4 after being adjusted the tilt thereof. As shown in FIG. 4 and FIG. 5, when the tilt of the holder 140 is adjusted, the lens assembly 150 is shifted along with the holder 140 (e.g., a left shift or a right shift), so that the lens assembly 150 may be adjusted to a position that the optic axis L of the lens assembly 150 is perpendicular to the image sensor 120. In addition, when the robotic arm 210 adjust the tilt of the holder 140, an included angle between the optic axis L of the lens assembly 150 and the image sensor 120 may be detected. Until the optic axis L of the lens assembly 150 is perpendicular to the image sensor 120, the tilt of the holder 140 is stopped adjusting. As a result, due to the optic axis L of the lens assembly 150 perpendicular to the image sensor 120, the resolution of the corner region of an image that is formed by the image sensor 120 may be improved.

In this embodiment, since the image sensor 120 is oblique downward at the right side of FIG. 5, the holder 140 is also oblique downward at the right side of FIG. 5 after the robotic arm 210 adjusts the holder 140. In fact, the tilt of the holder 140 can be adjusted in six-axial directions (i.e., x, y, z, θx, θy, and θz directions) by the robotic arm 210 to ensure that the image sensor 120 in different oblique states can be perpendicular to the optic axis L of the lens assembly 150 after the lens assembly 150 is adjusted.

After the tilt of the holder 140 is adjusted, the holder 140 is oblique relative to the printed circuit board 110. Hence, a gap 132 may be formed between the holder 140 and the printed circuit board 110. At this time, the gap 132 may be filled with additional light-curing adhesive 130 to prevent one side of the holder 140 from suspending.

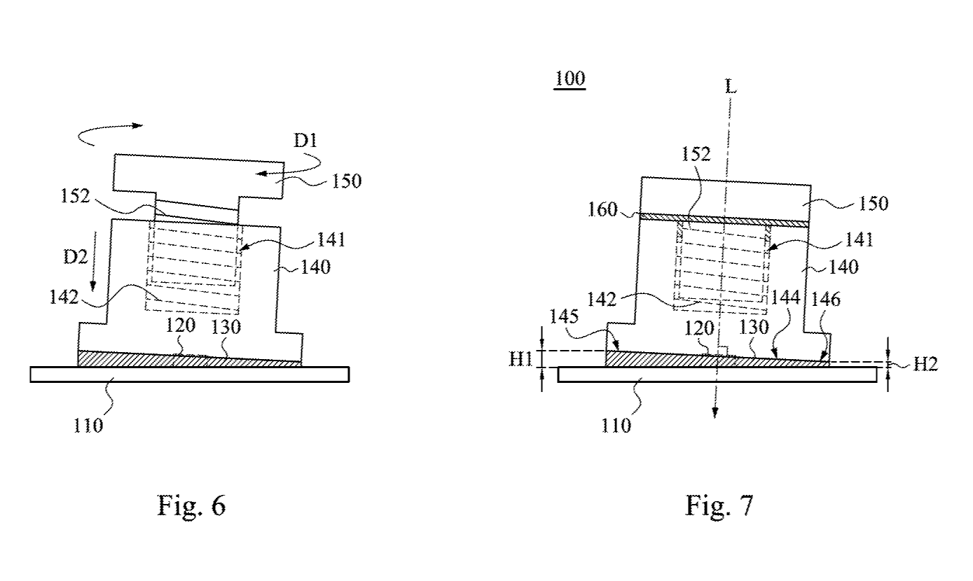

FIG. 6 is a schematic view of the gap 132 shown in FIG. 5 after being filled with the light-curing adhesive 130 and after the light-curing adhesive 130 is cured. As shown in FIG. 5 and FIG. 6, after the tilt of the holder 140 is adjusted and the light-curing adhesive 130 is dispensed in the gap 132, a light corresponding to the wavelength of the light-curing adhesive 130 can be utilized to irradiate the light-curing adhesive 130 (e.g., an ultraviolet light), such that the light-curing adhesive 130 is pre-cured. Thereafter, the light-curing adhesive 130 is baked (e.g., 80° C.), such that the light-curing adhesive 130 is cured to fix the holder 140 to the printed circuit board 110. As a result, the holder 140 can maintain its tilt on the printed circuit board 110. After the light-curing adhesive 130 is cured, the lens assembly 150 may be rotated (e.g., in a direction D1) to move to a focal plane in a vertical direction (e.g., in a direction D2) through the first and second threads 142, 152 again. Until the lens assembly 150 is on the focal plane, the lens assembly 150 is stopped rotating. In addition, when the lens assembly 150 is moved in the vertical direction, an image of the image sensor may be detected. When the central region of the image is in the clearest state, it is referred that the lens assembly 150 is just located on the focal plane, and the lens assembly 150 may be stopped rotating. As a result, due to the lens assembly 150 on the focal plane, the resolution of the central region of an image may be improved.

FIG. 7 is a schematic view of the lens assembly 150 and the holder 140 shown in FIG. 6 after being fixed by glue 160. As shown in FIG. 6 and FIG. 7, after the lens assembly 150 is moved to the focal plane, the glue 160 may be utilized to fix the lens assembly 150 to the holder 140. As a result, the lens assembly 150 can be hold at the position of the focal plane in the holder 140, and the optical module 100 of the present invention is obtained.

The optical module 100 includes the printed circuit board 110, the image sensor 120, the holder 140, and the lens assembly 150. The image sensor 120 is located on the printed circuit board 110. The holder 140 is located on the printed circuit board 110 and surrounds the image sensor 120. The holder 140 has the accommodating space 141 and the first thread 142, and the first thread 142 is located on the wall surface of the holder 140 facing the accommodating space 141. At least a portion of the lens assembly 150 is located in the accommodating space 141. The portion of the lens assembly 150 in the accommodating space 141 has the second thread 152 that may be coupled to the first thread 142. The holder 140 is oblique relative to the printed circuit board 110, such that the optic axis L of the lens assembly 150 is perpendicular to the image sensor 120.

In the lens focusing method and the optical module 100 of the present invention, the holder 140 is combined with the lens assembly 150 through the first and second threads 142, 152. When the tilt of the holder 140 is adjusted, the lens assembly 150 is shifted along with the holder 140 (e.g., a left shift or a right shift). Hence, the lens assembly 150 may be adjusted to a position that the optic axis L of the lens assembly 150 is perpendicular to the image sensor 120. After the tilt of the holder 140 is adjusted, the lens assembly 150 may be rotated to move in a vertical direction in the holder 140 (e.g., up and down). Therefore, the lens assembly 150 may be adjusted to a position of the focal plane. As a result, the lens focusing method and the optical module 100 of the present invention can improve not only the resolution of the corner region of an image, but also the resolution of the central region of an image.

In this embodiment, the optical module 100 may further include the light-curing adhesive 130. The light-curing adhesive 130 is between the holder 140 and the printed circuit board 110 to adhere the holder 140 to the printed circuit board 110. The surface 144 of the holder 140 facing the printed circuit board 110 has a first edge 145 and a second edge 146 that is opposite to the first edge 145, and a distance H1 between the first edge 145 and the printed circuit board 110 is greater than a distance H2 between the second edge 146 and the printed circuit board 110. In other words, as shown in FIG. 7, a thickness H1 of the light-curing adhesive 130 between the first edge 145 and the printed circuit board 110 is greater than a thickness H2 of the light-curing adhesive 130 between the second edge 146 and the printed circuit board 110.

Moreover, the optical module 100 may further include the glue 160. The glue 160 is between the lens assembly 150 and the holder 140 to adhere the lens assembly 150 to the holder 140.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims.

What is claimed is:

1. A lens focusing method, comprising:
(a) disposing a holder on a printed circuit board, such that the holder surrounds an image sensor that is on the printed circuit board;
(b) rotating a lens assembly for being positioned in the holder through a first thread of the holder and a second thread of the lens assembly;
(c) adjusting a tilt of the holder, such that an optic axis of the lens assembly is perpendicular to the image sensor; and
(d) rotating the lens assembly for being moved to a focal plane in a vertical direction through the first and second threads again.

2. The lens focusing method of claim 1, further comprising:
dispensing a light-curing adhesive to the printed circuit board, wherein the light-curing adhesive surrounds the image sensor.

3. The lens focusing method of claim 2, wherein the light-curing adhesive is an ultraviolet curing adhesive.

4. The lens focusing method of claim 2, wherein step (a) comprises:
utilizing the light-curing adhesive for adhering the holder to the printed circuit board.

5. The lens focusing method of claim 2, wherein after step (b), a gap is formed between the holder and the printed circuit board, and the lens focusing method further comprises:
filling the gap with the light-curing adhesive.

6. The lens focusing method of claim 5, further comprising:
utilizing a light that corresponds to a wavelength of the light-curing adhesive for irradiating the light-curing adhesive, such that the light-curing adhesive is pre-cured.

7. The lens focusing method of claim 6, further comprising:
baking the light-curing adhesive, such that the light-curing adhesive is cured to fix the holder to the printed circuit board.

8. The lens focusing method of claim 1, wherein step (c) comprises:
utilizing a robotic arm for clamping the holder, such that the tilt of the holder is adjusted.

9. The lens focusing method of claim 8, wherein step (c) comprises:
detecting an included angle between an optic axis of the lens assembly and the image sensor.

10. The lens focusing method of claim 8, wherein the tilt of the holder is adjusted in six-axial directions by the robotic arm.

11. The lens focusing method of claim 1, wherein step (d) comprises:
detecting an image of the image sensor when the lens assembly is moved in the vertical direction, wherein when a central region of the image is in a clearest state, the lens assembly is located on the focal plane.

12. The lens focusing method of claim 1, wherein after step (d), the lens focusing method further comprises:
utilizing glue for fixing the lens assembly to the holder.

13. An optical module, comprising:
a printed circuit board;
an image sensor located on the printed circuit board;
a holder located on the printed circuit board and surrounding the image sensor, wherein the holder has an accommodating space and a first thread, and the first thread is located on a wall surface of the holder facing the accommodating space; and
a lens assembly, wherein at least a portion of the lens assembly is located in the accommodating space and has a second thread, wherein the holder is oblique relative to the printed circuit board, such that an optic axis of the lens assembly is perpendicular to the image sensor.

14. The optical module of claim 13, further comprising:
a light-curing adhesive between the holder and the printed circuit board.

15. The optical module of claim 14, wherein the light-curing adhesive is an ultraviolet curing adhesive.

16. The optical module of claim 15, wherein a surface of the holder facing the printed circuit board has a first edge and a second edge opposite to the first edge, and a distance between the first edge and the printed circuit board is greater than a distance between the second edge and the printed circuit board.

17. The optical module of claim 16, wherein a thickness of the light-curing adhesive between the first edge and the printed circuit board is greater than a thickness of the light-curing adhesive between the second edge and the printed circuit board.

18. The optical module of claim 13, further comprising:
glue between the lens assembly and the holder.
